(19) United States
(12) Patent Application Publication
(10) Pub. No.: US 2022/0247286 A1
(43) Pub. Date: Aug. 4, 2022

(54) CORE BODY, MOTOR, CONNECTION MEMBER, AND METHOD FOR MANUFACTURING CORE BODY

(71) Applicant: Nidec Corporation, Kyoto (JP)

(72) Inventors: Shigeru MAEDA, Kyoto (JP); Tatsuki SHIGETA, Kyoto (JP)

(21) Appl. No.: 17/573,665

(22) Filed: Jan. 12, 2022

(30) Foreign Application Priority Data
Jan. 29, 2021 (JP) 2021-012967

(51) Int. Cl. H02K 15/02; H02K 1/18; H02K 1/16; H02K 1/27

(52) U.S. Cl. CPC H02K 15/02; H02K 1/27; H02K 1/16; H02K 1/18

(57) ABSTRACT

A core body has an annular shape surrounding a central axis extending in an axial direction and includes core pieces connected to each other along a circumferential direction and each including a core piece body and a connector fixed to the core piece body. The connectors in the core pieces adjacent to each other in the circumferential direction include rotating connection portions connected to each other to be rotatable about a rotation axis extending in the axial direction, and rotation stopping portions which come into contact with each other in a radial direction.

### CROSS-REFERENCE TO RELATED APPLICATIONS

The present application claims priority under 35 U.S.C. § 119 to Japanese Patent Application No. 2021-012967, filed on Jan. 29, 2021, the entire contents of which are hereby incorporated herein by reference.

### 1. Field of the Invention

The present disclosure relates to a core body, a motor, a connector, and a method for manufacturing the core body.

### 2. Background

For example, conventionally, a stator core is known in which a plurality of laminated cores are connected in a circumferential direction.

In the stator core as described above, the number of man-hours and time required to assemble the stator core are likely to increase, for example, since a jig or a mold is required when connecting the plurality of laminated cores. Therefore, an efficiency of assembling the stator core may not be sufficiently improved.

### SUMMARY

According to an example embodiment of the present disclosure, a core body has an annular shape surrounding a central axis extending in an axial direction and includes core pieces connected to each other along a circumferential direction. The core pieces include a core piece body, and a connector fixed to the core piece body. The connectors in the core pieces adjacent to each other in the circumferential direction include rotating connection portions which are connected to each other to be rotatable about a rotation axis extending in the axial direction, and rotation stopping portions which come into contact with each other in a radial direction.

According to another example embodiment of the present disclosure, a core body has an annular shape surrounding a central axis extending in an axial direction and includes core pieces connected to each other along a circumferential direction. The core pieces each include a core piece body. The core piece body includes a hole recessed in the axial direction. In the core piece bodies of the core pieces adjacent to each other in the circumferential direction, a concave surface portion provided at a circumferential end portion of one of the core piece bodies is fitted into a convex surface portion provided at a circumferential end portion of another of the core piece bodies. The concave surface portion and the convex surface portion each have an arc shape centered on a center of the hole when viewed in the axial direction.

According to a further example embodiment of the present disclosure, a motor includes the core body according to the example embodiment of the present disclosure described above.

According to an additional example embodiment of the present disclosure, a connector is provided in each of multiple core pieces connected to each other along a circumferential direction in a core body having an annular shape surrounding a central axis extending in an axial direction. The connector includes a rotating connection portion that is connected to the connector provided in the core piece adjacent in the circumferential direction to be rotatable about a rotation axis extending in the axial direction, and a rotation stopping portion that is in radially contact with the connector provided on the core piece adjacent in the circumferential direction.

According to another example embodiment of the present disclosure, a method of manufacturing a core body includes fixing connectors to core piece bodies, connecting the connectors to be mutually rotatable about a rotation axis, and assembling the core piece bodies connected to each other into an annular shape by relatively rotating the core piece bodies about the rotation axis.

According to yet another example embodiment of the present disclosure, a method of manufacturing a core body includes molding the core body using a plurality of connectors connected in a circumferential direction. The molding of the core body includes attaching the connector to the core piece body, connecting the connectors to the hole to be rotatable about a rotation axis passing through a center of the hole, assembling the core piece bodies connected to each other into an annular shape by relatively rotating the core piece bodies about the rotation axis, fixing the core piece bodies to each other, and detaching the connector from the core piece body.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal sectional view of a motor according to a first example embodiment of the present disclosure.

FIG. 2 is a top view of the core body according to the first example embodiment.

FIG. 3 is a perspective view of a core piece according to the first example embodiment.

FIG. 4 is an exploded perspective view of a portion of the core body according to the first example embodiment.

FIG. 5 is a view illustrating an operation of a connector according to the first example embodiment.

FIG. 6 is a longitudinal sectional view of a motor according to a second example embodiment of the present disclosure.

FIG. 7 is a perspective view of a portion of a core body according to the second example embodiment.

### DETAILED DESCRIPTION

In the following description, a positive side (+Z side) of a Z-axis direction is referred to as an “upper side”, and a negative side (−Z side) of the Z-axis direction is referred to as a “lower side”. Incidentally, the upper side and the lower side are directions used merely for description, and do not limit the posture of a rotor 30 and a motor 1 during use. A central axis J illustrated in the drawing is an imaginary line extending in parallel with the Z-axis direction. In the following description, unless otherwise specified, a direction (Z-axis direction) parallel to the central axis J is simply referred to as an “axial direction”, a radial direction centered on the central axis J is simply referred to as a “radial direction”, and a circumferential direction centered on the central axis J, that is, around the central axis J is simply referred to as a “circumferential direction”. Incidentally, when viewed from above, a clockwise direction corresponds to one side (+θ side in the drawing) in the circumferential direction, and a counterclockwise direction corresponds to the other side (−θ side in the drawing) in the circumferential direction.

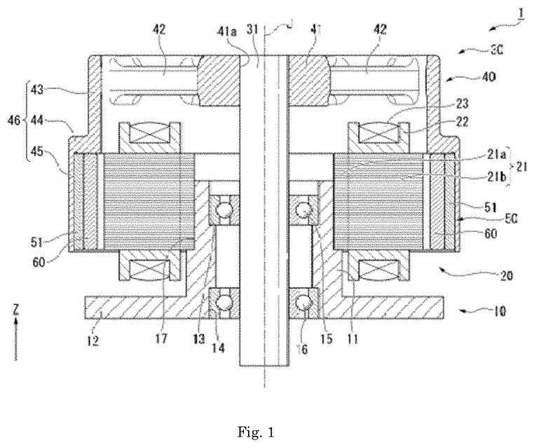

The motor 1 of the first example embodiment illustrated in FIG. 1 is an outer rotor type motor. As illustrated in FIG. 1, the motor 1 includes a base member 10, a stator 20, and the rotor 30.

The base member 10 includes a base cylindrical portion 11 and a flange portion 12 expanding radially outward from a lower end portion of the base cylindrical portion 11. The base cylindrical portion 11 has a first large inner diameter portion 13 and a second large inner diameter portion 14 having large inner diameters at an upper end and a lower end. The first large inner diameter portion 13 accommodates a first bearing 15. The second large inner diameter portion 14 accommodates a second bearing 16. The upper portion of the base cylindrical portion 11 is a small outer diameter portion 17 having an outer diameter smaller than that of the lower portion of the base cylindrical portion 11.

The stator 20 is positioned on the radially inner side of the rotor 30. The stator 20 is fixed to the base member 10. The stator 20 includes a stator core 21, a plurality of insulators 22, and a plurality of coils 23.

The stator core 21 includes a core back portion 21a having an annular shape centered on the central axis J and a plurality of tooth portions 21b extending radially outward from the outer circumferential end of the core back portion 21a. The small outer diameter portion 17 of the base cylindrical portion 11 is fitted inside the annular core back portion 21a. The core back portion 21a is fixed to the small outer diameter portion 17 by press fitting, for example. Although not illustrated, the plurality of tooth portions 21b are arranged at intervals in the circumferential direction.

The coil 23 is made of a coil wire wound in multiple layers. Each of the plurality of coils 23 is attached to the tooth portion 21b via the insulator 22.

The rotor 30 is rotatable about the central axis J extending in the axial direction. The rotor 30 includes a shaft 31, a rotor holder 40, a rotor core 50, and a rotor magnet 60. The shaft 31 has a columnar shape centered on the central axis J and extending in the axial direction. The shaft 31 is rotatably supported by the first bearing 15 and the second bearing 16.

The rotor holder 40 is fixed to the shaft 31. The rotor holder 40 includes a shaft fixing portion 41 fixed to the shaft 31, a plurality of connection portions 42 extending radially outward from the shaft fixing portion 41, and a cylindrical portion 46 connected to the shaft fixing portion 41 via the plurality of connection portions 42. The shaft fixing portion 41 has a central through-hole 41a centered on the central axis J. The upper end portion of the shaft 31 is fitted and fixed to the central through-hole 41a.

In this example embodiment, the cylindrical portion 46 has a cylindrical shape which is centered on the central axis J and is open on both axial sides. The cylindrical portion 46 includes an upper cylindrical portion 43, a support portion 44, and a lower cylindrical portion 45. The upper cylindrical portion 43 is an upper portion of the cylindrical portion 46. The radial outer end portions of the plurality of connection portions 42 are connected to the inner circumferential surface at the upper end portion of the upper cylindrical portion 43.

The support portion 44 protrudes radially outward from the lower end portion of the upper cylindrical portion 43. In this example embodiment, the support portion 44 has an annular shape centered on the central axis J. The support portion 44 supports the rotor core 50 from above.

The lower cylindrical portion 45 extends downward from the radial outer edge portion of the support portion 44. The lower cylindrical portion 45 is the lower portion of the cylindrical portion 46. The rotor core 50 is fixed to the inner circumferential surface of the lower cylindrical portion 45. The lower cylindrical portion 45 surrounds the rotor core 50 from the radially outer side. The radial thickness of the wall portion configuring the lower cylindrical portion 45 is smaller than the radial thickness of the wall portion configuring the upper cylindrical portion 43.

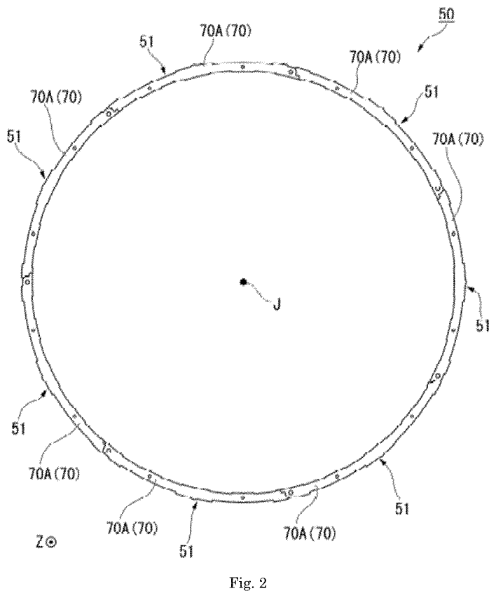

In this example embodiment, the rotor core 50 is an annular core body surrounding the central axis J extending in the axial direction. The rotor magnet 60 is fixed to the radially inner surface of the rotor core 50. The rotor core 50 is fitted into the lower cylindrical portion 45. The radially outer surface of the rotor core 50 is in contact with the inner circumferential surface of the lower cylindrical portion 45. The upper surface of the rotor core 50 is in contact with the lower surface of the support portion 44. As illustrated in FIG. 2, in this example embodiment, the rotor core 50 is configured by connecting a plurality of core pieces 51 to each other along the circumferential direction. The rotor core 50 of this example embodiment is configured by connecting seven core pieces 51 in an annular shape.

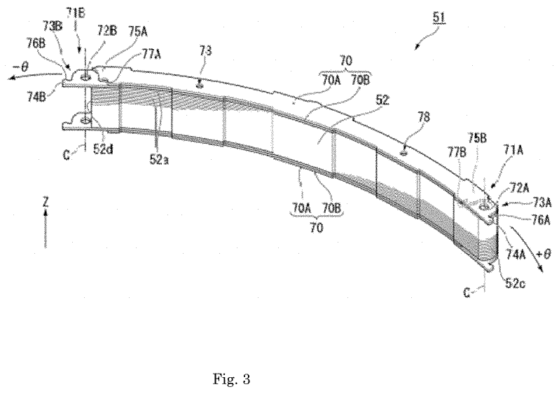

As illustrated in FIG. 3, the core piece 51 includes a core piece body 52 and a connector 70 fixed to the core piece body 52. In this example embodiment, the connectors 70 are provided on both axial sides of the core piece body 52. The connector 70 provided on the upper side of the core piece body 52 and the connector 70 provided on the lower side of the core piece body 52 have the same configuration except that the order of laminating a first plate-shaped portion 70A and a second plate-shaped portion 70B described later is reversed in the axial direction. Therefore, in the following description, only the connector 70 provided on the upper side of the core piece body 52 may be described as a representative.

The core piece body 52 is configured by laminating a plurality of third plate-shaped portions 52a in the axial direction. The third plate-shaped portion 52a has a plate shape of which the plate surface faces the axial direction. The third plate-shaped portion 52a is, for example, an electromagnetic steel sheet.

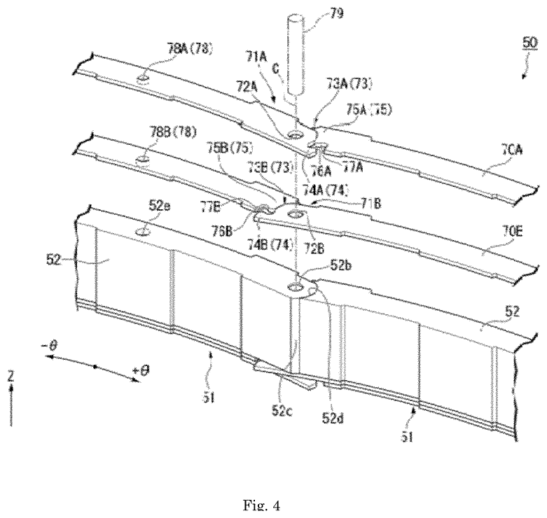

As illustrated in FIG. 4, the core piece body 52 has a hole 52b recessed in the axial direction. The hole 52b is provided at an end portion of the core piece body 52 on one side (+θ side) in the circumferential direction. In this example embodiment, the hole 52b penetrates the core piece body 52 in the axial direction. The hole 52b is a hole centered on a rotation axis C extending in the axial direction.

The core piece body 52 has a convex surface portion 52c protruding to one side in the circumferential direction at an end portion on one side (+θ side) in the circumferential direction. Further, the core piece body 52 has a concave surface portion 52d recessed to one side in the circumferential direction at an end portion on the other side (−θ side) in the circumferential direction. In the core piece bodies 52 of the core pieces 51 adjacent to each other in the circumferential direction, the convex surface portion 52c provided at the circumferential end portion of one core piece body 52 is fitted to the concave surface portion 52d provided at the circumferential end portion of the other core piece body 52. The concave surface portion 52d and the convex surface portion 52c have an arc shape centered on the center of the hole 52b, that is, the rotation axis C when viewed in the axial direction.

In this example embodiment, the connector 70 includes the first plate-shaped portion 70A and the second plate-shaped portion 70B which overlap each other in the axial direction. The outer shape of the first plate-shaped portion 70A and the outer shape of the second plate-shaped portion 70B are shapes reversed in the circumferential direction when viewed in the axial direction. The first plate-shaped portion 70A is laminated on the upper side of the second plate-shaped portion 70B. In this example embodiment, the connectors 70 are provided on both axial sides of the core piece body 52, and thus the first plate-shaped portion 70A, the second plate-shaped portion 70B, the core piece body 52, the second plate-shaped portion 70B, and the first plate-shaped portion 70A are arranged in this order from the upper side to configure the core piece 51. In this example embodiment, the material of the first plate-shaped portion 70A and the material of the second plate-shaped portion 70B are the same as the material of the third plate-shaped portion 52a. That is, the first plate-shaped portion 70A and the second plate-shaped portion 70B are electromagnetic steel sheets similar to the third plate-shaped portion 52a of the core piece body 52.

The first plate-shaped portion 70A has a first protruding portion 71A protruding to one side (+θ side) in the circumferential direction with respect to the second plate-shaped portion 70B. The second plate-shaped portion 70B has a second protruding portion 71B protruding to the other side (−θ side) in the circumferential direction with respect to the first plate-shaped portion 70A. In the core pieces 51 adjacent to each other in the circumferential direction, the first protruding portion 71A of one core piece 51 and the second protruding portion 71B of the other core piece 51 overlap each other when viewed in the axial direction. More specifically, in the core pieces 51 adjacent to each other in the circumferential direction, the first protruding portion 71A of one core piece 51 is laminated on the upper side of the second protruding portion 71B of the other core piece 51.

The first protruding portion 71A has a first through-hole 72A. The second protruding portion 71B has a second through-hole 72B. In the core pieces 51 adjacent to each other in the circumferential direction, the first through-hole 72A in one core piece 51 and the second through-hole 72B in the other core piece 51 overlap each other when viewed in the axial direction. Further, the first through-hole 72A and the second through-hole 72B overlap with the hole 52b of the core piece body 52 when viewed in the axial direction.

In the core pieces 51 adjacent to each other in the circumferential direction, the connector 70 includes a rotating connection portion 73A and a rotating connection portion 73B which are respectively connected to the first protruding portion 71A and the second protruding portion 71B to be rotatable about the rotation axis C extending in the axial direction. The rotating connection portion 73A is a portion of the first protruding portion 71A where the first through-hole 72A is provided. The rotating connection portion 73B is a portion of the second protruding portion 71B where the second through-hole 72B is provided. The rotation axis C passes through the centers of the first through-hole 72A, the second through-hole 72B, and the hole 52b of the core piece body 52. In this example embodiment, a fixing pin 79 extending along the rotation axis C is inserted into the first through-hole 72A, the second through-hole 72B, and the hole 52b. In this example embodiment, the radially outer portion at the end portion of the rotating connection portion 73A on one side (+θ side) in the circumferential direction has an arc shape centered on the rotation axis C when viewed in the axial direction. The radially outer portion at the end portion of the rotating connection portion 73B on the other side (−θ side) in the circumferential direction has an arc shape centered on the rotation axis C when viewed in the axial direction. In the following description, when the rotating connection portion 73A and the rotating connection portion 73B are not distinguished, the rotating connection portion 73A and the rotating connection portion 73B are collectively referred to as a rotating connection portion 73.

The first plate-shaped portion 70A includes a rotation stopping portion 74A and a rotation stopping portion 75A. The rotation stopping portions 74A and 75A are provided at both end portions of the first plate-shaped portion 70A in the circumferential direction. The rotation stopping portion 74A provided at the end portion of the first plate-shaped portion 70A on one side (+θ side) in the circumferential direction is provided closer to the radially inner side. The rotation stopping portion 74A protrudes to one side in the circumferential direction from the radially inner end portion of the rotating connection portion 73A. The rotation stopping portion 75A provided at the end portion of the first plate-shaped portion 70A on the other side (−θ side) in the circumferential direction is provided closer to the radially outer side. The rotation stopping portion 75A protrudes toward the other side in the circumferential direction. The rotation stopping portion 74A and the other rotation stopping portion 75A in contact therewith in the radial direction have a fitting portion 76A and a fitting portion 77A fitted to each other. The fitting portion 76A is provided on the radially outer side of the rotation stopping portion 74A. In this example embodiment, the fitting portion 76 has a shape having a convex portion protruding radially outward and a concave portion adjacent to the other side of the convex portion in the circumferential direction and recessed radially inward. The fitting portion 77A is provided on the radially inner side of the rotation stopping portion 75A. The fitting portion 77A has a shape having a concave portion recessed radially outward and a convex portion adjacent to the other side of the concave portion in the circumferential direction and protruding radially inward. The convex portion of the fitting portion 76A fits into the concave portion of the fitting portion 77A, and the convex portion of the fitting portion 77A fits into the concave portion of the fitting portion 76A.

The second plate-shaped portion 70B includes a rotation stopping portion 74B and a rotation stopping portion 75B. The rotation stopping portions 74B and 75B are provided at both end portions of the second plate-shaped portion 70B in the circumferential direction. The rotation stopping portion 75B provided at the end portion of the second plate-shaped portion 70B on one side (+θ side) in the circumferential direction is provided closer to the radially outer side. The rotation stopping portion 75B protrudes toward one side in the circumferential direction. The rotation stopping portion 74B provided at the end portion of the second plate-shaped portion 70B on the other side (−θ side) in the circumferential direction is provided closer to the radially inner side. The rotation stopping portion 74B protrudes to the other side in the circumferential direction from the radially inner end portion of the rotating connection portion 73B. The rotation stopping portion 74B and the other rotation stopping portion 75B in contact therewith in the radial direction have fitting portions 76B fitted to each other. The fitting portion 76B is provided on the radially outer side of the rotation stopping portion 74B. In this example embodiment, the fitting portion 76B has a shape having a convex portion protruding radially outward and a concave portion adjacent to one side of the convex portion in the circumferential direction and recessed radially inward. Further, a fitting portion 77B is provided on the radially inner side of the rotation stopping portion 75B. The fitting portion 77B has a shape including a concave portion recessed radially outward and a convex portion adjacent to one side of the concave portion in the circumferential direction and protruding radially inward. The convex portion of the fitting portion 76B fits into the concave portion of the fitting portion 77B, and the convex portion of the fitting portion 77B fits into the concave portion of the fitting portion 76B.

In the core pieces 51 adjacent to each other in the circumferential direction, the rotation stopping portion 74A of the first plate-shaped portion 70A provided in one core piece 51 can come into contact with the rotation stopping portion 75A of the first plate-shaped portion 70A provided in the other core piece 51 in the radial direction. The rotation stopping portion 74A of the first plate-shaped portion 70A provided on one core piece 51 and the rotation stopping portion 75A of the first plate-shaped portion 70A provided on the other core piece 51 are in contact with each other in the radial direction in a state where the core pieces 51 adjacent to each other in the circumferential direction are combined in an arc shape centered on the central axis J. In the rotation stopping portion 74A and the rotation stopping portion 75A in contact with each other in the radial direction, the rotation stopping portion 74A is positioned on the radially inner side of the rotation stopping portion 75A. In a state where the rotation stopping portion 74A and the rotation stopping portion 75A are in contact with each other, the fitting portion 76A of the rotation stopping portion 74A and the fitting portion 77A of the rotation stopping portion 75A are fitted to each other.

In the core pieces 51 adjacent to each other in the circumferential direction, the rotation stopping portion 74B of the second plate-shaped portion 70B provided in one core piece 51 can come into contact with the rotation stopping portion 75B of the second plate-shaped portion 70B provided in the other core piece 51 in the radial direction. The rotation stopping portion 74B of the second plate-shaped portion 70B provided on one core piece 51 and the rotation stopping portion 75B of the second plate-shaped portion 70B provided on the other core piece 51 are in contact with each other in the radial direction in a state where the core pieces 51 adjacent to each other in the circumferential direction are combined in an arc shape centered on the central axis J. In the rotation stopping portion 74B and the rotation stopping portion 75B in contact with each other in the radial direction, the rotation stopping portion 74B is positioned on the radially inner side of the rotation stopping portion 75B. In a state where the rotation stopping portion 74B and the rotation stopping portion 75B are in contact with each other, the fitting portion 76B of the rotation stopping portion 74B and the fitting portion 77B of the rotation stopping portion 75B are fitted to each other.

In this example embodiment, in the core pieces 51 adjacent to each other in the circumferential direction, the rotating connection portion 73A and the rotating connection portion 73B are rotatable about the rotation axis C within a range in which the rotation stopping portion 74A and the rotation stopping portion 75A are not in contact with each other in the radial direction and the rotation stopping portion 74B and the rotation stopping portion 75B are not in contact with each other in the radial direction.

In the following description, when the rotation stopping portion 74A and the rotation stopping portion 74B are not distinguished, the rotation stopping portion 74A and the rotation stopping portion 74B are collectively referred to as a rotation stopping portion 74. When the rotation stopping portion 75A and the rotation stopping portion 75B are not distinguished from each other, the rotation stopping portion 75A and the rotation stopping portion 75B are collectively referred to as a rotation stopping portion 75.

In this example embodiment, the connector 70 further includes a fixing portion 78. In this example embodiment, the connector 70 includes, as the fixing portion 78, a first fixing portion 78A provided on the first plate-shaped portion 70A and a second fixing portion 78B provided on the second plate-shaped portion 70B. The first fixing portion 78A and the second fixing portion 78B are portions formed by caulking a part of each plate-shaped member downward. The first fixing portion 78A and the second fixing portion 78B have a concave portion recessed downward from the upper surface of each plate-shaped member and a convex portion recessed downward from the lower surface of each plate-shaped member. The first fixing portion 78A and the second fixing portion 78B have a circular shape when viewed in the axial direction. The convex portion of the first fixing portion 78A protruding downward is fitted and fixed from above to the concave portion of the second fixing portion 78B recessed downward.

Accordingly, the first fixing portion 78A and the second fixing portion 78B are fixed, and the first plate-shaped portion 70A and the second plate-shaped portion 70B are fixed.

In this example embodiment, a fixing hole 52e is provided in the core piece body 52 at a position where the first fixing portion 78A and the second fixing portion 78B overlap each other when viewed in the axial direction. The fixing hole 52e is a circular hole recessed downward. The convex portion of the second fixing portion 78B protruding downward is fitted and fixed to the fixing hole 52e from above. Accordingly, the fixing portion 78 is fixed to the core piece body 52, and the first plate-shaped portion 70A and the second plate-shaped portion 70B fixed to each other are fixed to the core piece body 52.

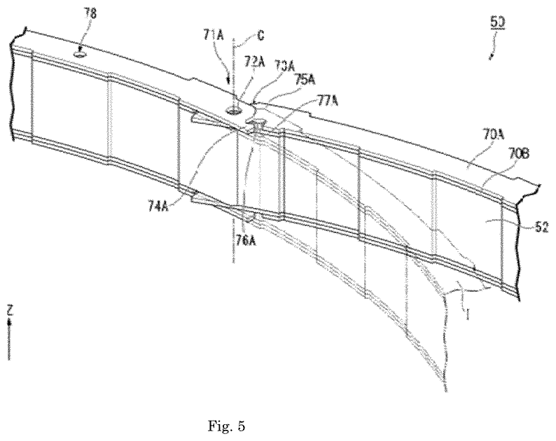

According to this example embodiment, the rotor core 50 is an annular core body surrounding the central axis J extending in the axial direction, and includes the plurality of core pieces 51 connected to each other along the circumferential direction. The core piece 51 includes the core piece body 52 and the connector 70 fixed to the core piece body 52. The connectors 70 in the core pieces 51 adjacent to each other in the circumferential direction include the rotating connection portions 73 which are connected to each other to be rotatable about the rotation axis C extending in the axial direction, and the rotation stopping portions 74 and 75 in contact with each other in the radial direction. Therefore, when the core pieces 51 adjacent to each other in the circumferential direction are connected via the rotating connection portion 73, as indicated by a solid line in FIG. 5, the core pieces 51 can be connected to each other so as to be rotatable about the rotation axis C without being combined in an arc shape. On the other hand, since the connectors 70 of the core pieces 51 adjacent to each other in the circumferential direction have the rotation stopping portions 74 and 75 in contact with each other in the radial direction, the rotation of the core pieces 51 can be stopped at a position where the core pieces 51 adjacent to each other in the circumferential direction are combined in an arc shape. Accordingly, the core pieces 51 adjacent to each other in the circumferential direction can be combined in an arc shape. Therefore, by similarly connecting the core pieces 51 in an arc shape, the rotor core 50 can be assembled in an annular shape along an imaginary annular ring I indicated by a two-dot chain line in FIG. 5. The imaginary annular ring I has an annular shape centered on the central axis J, and is an imaginary line indicating the outer shape of the rotor core 50 when assembled in an annular shape.

In addition, as described above, the one core piece 51 and the other core piece 51 can be connected in a state opened more than the target imaginary annular ring I, and thus the core pieces 51 can be connected without being positioned along the imaginary annular ring I. Accordingly, it is possible to improve the degree of freedom in assembly when the plurality of core pieces 51 are connected and assembled.

As described above, according to this example embodiment, the rotor core 50 can be easily assembled by assembling the plurality of core pieces 51 in an annular shape without using a jig or a mold. Therefore, the efficiency of assembling the rotor core 50 as an annular core body can be improved.

The core pieces 51 adjacent to each other in the circumferential direction are connected by the connector 70 fixed to the core piece body 52. In this configuration, for example, as compared with a case where the core piece bodies 52 are connected to each other by welding, it is possible to suppress conduction between the third plate-shaped portions 52a configuring the core piece body 52. Therefore, deterioration of magnetic characteristics of the core piece body 52 can be suppressed.

According to this example embodiment, the connector 70 includes the first plate-shaped portion 70A and the second plate-shaped portion 70B which overlap with each other in the axial direction. The first plate-shaped portion 70A has a first protruding portion 71A protruding to one side (+θ side) in the circumferential direction with respect to the second plate-shaped portion 70B. The second plate-shaped portion 70B has the second protruding portion 71B protruding to the other side (−θ side) in the circumferential direction with respect to the first plate-shaped portion 70A. In the core pieces 51 adjacent to each other in the circumferential direction, the first protruding portion 71A of one core piece 51 and the second protruding portion 71B of the other core piece overlap each other when viewed in the axial direction, and the rotating connection portion 73 is provided in each of the first protruding portion 71A and the second protruding portion 71B. In this configuration, the connector 70 has the two plate-shaped members 70A and 70B. Thus, it is possible to easily adopt a configuration in which portions of the connectors 70 in the core pieces 51 adjacent to each other in the circumferential direction are axially laminated and rotatably connected, and other portions of the connectors 70 are brought into contact with each other in the radial direction. Therefore, the connection between the core pieces 51 and the rotation stop between the core pieces 51 can be easily performed by the connectors 70 provided in each core pieces 51.

According to this example embodiment, the first plate-shaped portion 70A and the second plate-shaped portion 70B each have the rotation stopping portions 74 and 75 at both end portions in the circumferential direction. Therefore, the rotation of the connectors 70 in the core pieces 51 adjacent to each other in the circumferential direction can be more stably stopped by the rotation stopping portions 74 and 75. Further, the rotation stopping portion 74A provided at the end portion of the first plate-shaped portion 70A on one side (+θ side) in the circumferential direction is provided closer to the radially inner side, and the rotation stopping portion 75A provided at the end portion of the first plate-shaped portion 70A on the other side (−θ side) in the circumferential direction is provided closer to the radially outer side. The rotation stopping portion 74B provided at the end portion of the second plate-shaped portion 70B on one side (+θ side) in the circumferential direction is provided closer to the radially outer side, and the rotation stopping portion 75B provided at the end portion of the second plate-shaped portion 70B on the other side (−θ side) in the circumferential direction is provided closer to the radially inner side. In such a configuration, a direction in which the first plate-shaped portions 70A of the core pieces 51 adjacent to each other in the circumferential direction rotate mutually to open and a direction in which the second plate-shaped portions 70B of the core pieces 51 adjacent to each other in the circumferential direction rotate mutually to open can be the same direction. Further, at the same time, a direction in which the rotation of the first plate-shaped portions 70A of the core pieces 51 adjacent to each other in the circumferential direction stop mutually and a direction in which the rotation of the second plate-shaped portions 70B of the core pieces 51 adjacent to each other in the circumferential direction stop mutually can be the same direction. Therefore, the core pieces 51 connected by the connector 70 can be easily rotated mutually to be assembled along the imaginary annular ring I. Accordingly, the assembly efficiency of the rotor core 50 can be further improved.

According to this example embodiment, the outer shape of the first plate-shaped portion 70A and the outer shape of the second plate-shaped portion 70B are reversed in the circumferential direction when viewed in the axial direction. In such a configuration, the first plate-shaped portion 70A and the second plate-shaped portion 70B can be manufactured by punching with the same mold. Therefore, the cost for manufacturing the connector 70 can be reduced.

According to this example embodiment, the rotating connection portions 73A and 73B have the through-holes 72A and 72B centered on the rotation axis C. In such a configuration, the first plate-shaped portion 70A and the second plate-shaped portion 70B can be fixed to be mutually rotatable by the fixing pin 79 inserted into the through-holes 72A and 72B. Further, for example, in a case where a hole having a bottom portion is provided in one of the rotating connection portions 73A and 73B and a convex portion fitted in the hole is provided in the other rotating connection portion to rotatably connect the rotating connection portions 73A and 73B to each other, the shapes of the rotating connection portions 73A and 73B are not reversed in the circumferential direction. Therefore, members having the same shape cannot be used for the first plate-shaped portion 70A and the second plate-shaped portion 70B. Therefore, when the first plate-shaped portion 70A and the second plate-shaped portion 70B are made, it is necessary to perform different processing or the like. On the other hand, in a configuration in which the through-holes 72A and 72B are provided in the rotating connection portions 73A and 73B, respectively, the shapes of the rotating connection portions 73A and 73B can be reversed in the circumferential direction. Accordingly, members having the same shape can be used for the first plate-shaped portion 70A and the second plate-shaped portion 70B. In other words, the first plate-shaped portion 70A and the second plate-shaped portion 70B can be formed by inverting and using the plate-shaped members formed by the same process. Therefore, the cost for manufacturing the first plate-shaped portion 70A and the second plate-shaped portion 70B can be reduced.

According to this example embodiment, the core piece body 52 has the hole 52b centered on the rotation axis C at a position where the first protruding portion 71A and the second protruding portion 71B overlapping each other overlap each other when viewed in the axial direction. In such a configuration, the fixing pin 79 inserted into the through-holes 72A and 72B can not only connect the connectors 70 of the core pieces 51 adjacent in the circumferential direction to be mutually rotatable, but also connect the connectors 70 at the rotating connection portions 73 to the core piece bodies 52. Therefore, the connectors 70 can be more stably connected to each other to be rotatable.

According to this example embodiment, the core piece body 52 has the plurality of third plate-shaped portions 52a laminated in the axial direction, and the material of the first plate-shaped portion 70A and the material of the second plate-shaped portion 70B are the same as the material of the third plate-shaped portion 52a. In such a configuration, the core piece body and the connector 70 can be made using the same material. Therefore, as compared with a case where the material of the connector 70 is different from the material of the core piece body 52, the number of types of materials used for manufacturing the rotor core 50 can be reduced. Accordingly, the manufacturing cost of the rotor core 50 can be easily reduced. Further, similarly to the core piece body 52, a magnetic flux can also flow through the connector 70. Therefore, the connector 70 as well as the core piece body 52 can also be used as a part of a magnetic circuit passing through the rotor core 50. Accordingly, even when the connector 70 is provided, it is possible to ensure the magnetic characteristics of the rotor core 50 while suppressing an axial increase in size of the rotor core 50.

According to this example embodiment, the rotation stopping portion 74 has the fitting portion 76 which fits with the fitting portion 77 of another rotation stopping portion 75 in contact in the radial direction. In such a configuration, compared to a case where the rotation stopping portion 74 and the rotation stopping portion 75 of the core pieces 51 adjacent to each other in the circumferential direction are simply in contact with each other in the radial direction, it is easier to hold the connectors 70 in a state where the rotation of the connectors is stopped.

According to this example embodiment, the connector 70 is provided on each of both axial sides of the core piece body 52. In such a configuration, as compared with a case where the connector 70 is provided only on one axial side of the core piece body 52, the core pieces 51 can be more stably connected to each other by the two connectors 70 on both axial sides.

According to this example embodiment, the core piece bodies 52 adjacent to each other in the circumferential direction are connected by fitting the convex surface portion 52c provided at the circumferential end portion of the other core piece body 52 to the concave surface portion 52d provided at the circumferential end portion of the one core piece body 52. The concave surface portion 52d and the convex surface portion 52c have an arc shape centered on the rotation axis C when viewed in the axial direction. In such a configuration, it is possible to reduce a gap in the circumferential direction between the core piece bodies 52 or to bring the core piece bodies into contact with each other while making the core piece bodies 52 adjacent in the circumferential direction to be mutually rotatable. Therefore, it is possible to suppress deterioration of magnetic characteristics due to the gap in the circumferential direction between the core piece bodies 52.

A method for manufacturing the rotor core 50 which is the core body of the first example embodiment includes an attachment process of attaching the connector 70 to the core piece body 52. In the attachment process of this example embodiment, the first plate-shaped portion 70A and the second plate-shaped portion 70B are overlapped at the axial end portion of the core piece body 52 in the axial direction. Here, the convex portion of the second fixing portion 78B provided in the second plate-shaped portion 70B is fitted into the fixing hole 52e provided in the core piece body 52. Further, the convex portion of the first fixing portion 78A provided on the first plate-shaped portion 70A is fitted into the concave portion of the second fixing portion 78B. Accordingly, the connector 70 and the core piece body 52 are fixed to each other. Incidentally, the connector 70 and the core piece body 52 may be bonded to each other by an adhesive.

The method for manufacturing the rotor core 50 according to the first example embodiment includes a connection process of connecting the connectors 70 to be mutually rotatable about the rotation axis C. In the connection process, the fixing pin 79 is inserted into the through-hole 72A of the first plate-shaped portion 70A, the second through-hole 72B of the second plate-shaped portion 70B, and the hole 52b of the core piece body 52.

The method for manufacturing the rotor core 50 according to the first example embodiment includes an assembly process of assembling the core piece bodies 52 connected to each other into an annular shape by relatively rotating the core piece bodies around the rotation axis C. In the assembly process, the core piece bodies 52 rotatably fixed around the rotation axis C by the connector 70 are relatively rotated mutually to assemble the core piece bodies into an arc shape along the imaginary annular ring I.

The annular rotor core 50 can be assembled by performing the attachment process, the connection process, and the assembly process described above for each core piece 51. Incidentally, the order of the attachment process, the connection process, and the assembly process described above is not limited within a feasible range. For example, after all the core pieces 51 subjected to the attachment process are connected by the connection process, the assembly process may be collectively performed on the plurality of connected core pieces 51 to assemble the plurality of core pieces 51 into an annular shape. Further, for example, the core pieces 51 may be sequentially assembled along the imaginary annular ring I by performing the assembly process every time the core pieces 51 subjected to the attachment process are connected by the connection process.

According to this example embodiment, the method for manufacturing the rotor core 50 includes the process of attaching the connector 70 to the core piece body 52, the process of connecting the connectors 70 to be mutually rotatable about the rotation axis C, and the process of assembling the core piece bodies 52 connected to each other into an annular shape by relatively rotating the core piece bodies about the rotation axis C. In such a configuration, the rotor core 50 can be assembled in an annular shape without adopting a method such as welding and press fitting. That is, the efficiency of assembling the annular rotor core 50 can be improved.

In a modification of the first example embodiment, the annular rotor core 50 mounted on the rotor 30 does not have the connector 70. That is, the connector 70 in the first example embodiment may be detached from the core piece body 52 after being used to assemble the rotor core 50.

The method for manufacturing the rotor core 50 according to the modification includes a molding process of molding the rotor core 50 using the plurality of connectors 70 connected in the circumferential direction. Similarly to the method of manufacturing the rotor core 50 of the first example embodiment, the molding process of molding the rotor core 50 includes the attachment process of attaching the connector 70 to the core piece body 52, the connection process of connecting the connectors 70 to be mutually rotatable about the rotation axis C, and the assembly process of assembling the core piece bodies 52 connected to each other into an annular shape by relatively rotating the core piece bodies about the rotation axis C.

The molding process of molding the rotor core 50 further includes a fixing process of fixing the core piece bodies 52 to each other and a detachment process of detaching the connector 70 from the core piece body 52. In the fixing process of fixing the core piece bodies 52 to each other, for example, the connection portion between the core piece bodies 52 is fixed with an adhesive or the like.

The order of the fixing process and the detachment process described above is not limited within a feasible range. The fixing process may be performed after the detachment process is performed, for example, an adhesive is injected into the hole 52b of the core piece body 52 after the fixing pin 79 is detached. In this case, for example, the detachment process and the fixing process may be performed after the rotor core 50 assembled in an annular shape by the connector 70 is inserted into the rotor holder 40. Accordingly, even when the detachment process is performed, the fixing process can be performed in a state where the core piece bodies 52 are suppressed from being displaced from each other. When the adhesive is injected into the hole 52b, the adhesive injected into the hole 52b penetrates between the laminated third plate-shaped portions 52a of the core piece body 52, and fixes the core piece bodies 52 between the convex surface portion 52c and the concave surface portion 52d.

According to this modification, the rotor core 50 is an annular core body surrounding the central axis J extending in the axial direction, and includes a plurality of core pieces 51 connected to each other along the circumferential direction. The core piece 51 includes the core piece body 52, the core piece body 52 includes the hole 52b recessed in the axial direction, in the core piece bodies 52 of the core pieces 51 adjacent to each other in the circumferential direction, the convex surface portion 52c provided at the circumferential end portion of one core piece body 52 is fitted to the concave surface portion 52d provided at the circumferential end portion of the other core piece body, and the concave surface portion 52d and the convex surface portion 52c have an arc shape centered on the center of the hole 52b when viewed in the axial direction. In such a configuration, the rotor core 50 can be assembled using the connector 70 by the above-described manufacturing method. Therefore, the assembly efficiency of the rotor core 50 can be improved. In addition, as compared with the rotor core 50 in which the connector 70 remains connected to the core piece body 52 as in the first example embodiment, the mass of the entire rotor core 50 can be reduced by the amount by which the mass of the connector 70 is removed. Further, in this modification, the connector 70 can be configured on the assumption that the connector is detached, a portion other than the rotating connection portion 73 and the rotation stopping portions 74 and 75 can be designed to have a high degree of freedom with respect to dimensions such as an outer shape and a thickness of the connector 70.

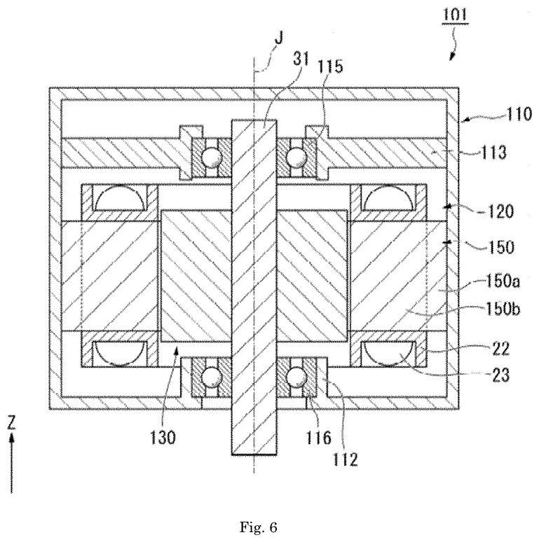

A motor 101 of a second example embodiment illustrated in FIG. 6 is an inner rotor type motor. As illustrated in FIG. 6, the motor 101 includes a housing member 110, a bearing holder 113, a stator 120, and a rotor 130. The housing member 110 accommodates the bearing holder 113, the stator 120, and the rotor 130 therein. Note that components identical to those of the above-described example embodiment are denoted by the same reference numeral, and the description will be omitted.

The rotor 130 is rotatable about the central axis J extending in the axial direction. The rotor 130 includes the shaft 31 and a rotor body 132. Although not illustrated, the rotor body 132 includes a rotor core fixed to the shaft 31 and a magnet fixed to the rotor core.

The stator 120 is positioned on the radially outer side of the rotor 130. The stator 120 is fixed to the housing member 110. The stator 120 includes a stator core 150, the plurality of insulators 22, and the plurality of coils 23.

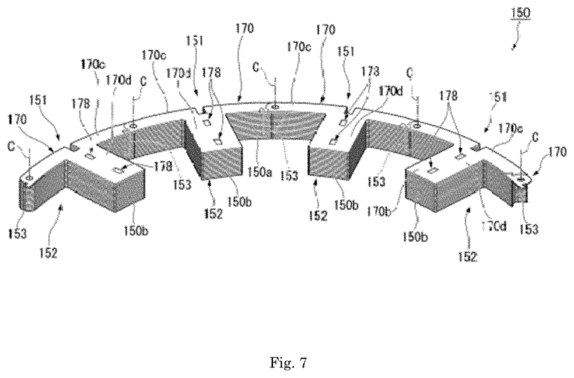

In this example embodiment, the stator core 150 is an annular core body surrounding the central axis J extending in the axial direction. FIG. 7 illustrates a part of the stator core 150 of the second example embodiment. The stator core 150 includes a core back portion 150a having an annular shape centered on the central axis J and a plurality of tooth portions 150b extending radially inward from the core back portion 150a. As illustrated in FIG. 6, the annular core back portion 150a is fitted to the inner circumferential surface of the housing member 110. The core back portion 150a is fixed in the housing member 110 by press fitting, for example. As illustrated in FIG. 7, the plurality of tooth portions 150b are arranged at intervals in the circumferential direction.

In this example embodiment, the stator core 150 is configured by connecting a plurality of core pieces 151 to each other along the circumferential direction. The stator core 150 of this example embodiment is configured by connecting seven core pieces 151 in an annular shape. In this example embodiment, each core piece 151 includes a part of the core back portion 150a and one tooth portion 150b.

The core piece 151 includes a core piece body 152 and a connector 170 fixed to the core piece body 152. In this example embodiment, the connector 170 is provided only on the upper side of the core piece body 152. The connector 170 is not provided on the lower side of the core piece body 152. The connector 170 has a shape overlapping the core piece body 152 when viewed in the axial direction, and has a portion 170c overlapping the core back portion 150a and a portion 170d overlapping the tooth portion 150b. Both end portions of the portion 170c, which overlaps the core back portion 150a, in the circumferential direction have the same configuration as both end portions of the connector 70 in the circumferential direction in the first example embodiment. Similarly to the first example embodiment, the connector 170 includes a first plate-shaped portion 170A and a second plate-shaped portion 170B which overlap each other in the axial direction. In this example embodiment, the fixing portion 178 fixed to the core piece body 152 is provided in the portion 170d overlapping the tooth portion 150b. Two fixing portions 178 are provided for each portion 170d.

In this example embodiment, the outer shape of the fixing portion 178 as viewed in the axial direction is rectangular. The fixing portion 178 is fixed to the core piece body 152 in the same manner as the fixing portion 78 of the first example embodiment.

In this example embodiment, the stator core 150 has the hole 153 provided across the core piece bodies 152 adjacent in the circumferential direction. The hole 153 is recessed upward from the lower surface of the stator core 150. An adhesive is injected into the hole 153 from the lower side of the core piece body 152. The adhesive injected into the hole 153 bonds the core piece bodies 152 adjacent to each other in the circumferential direction. In this configuration, the hole 153 is provided on the lower surface of the core piece body 152 in which the connector 170 is not arranged. Therefore, the adhesive can be injected into the hole 153 without detaching the connector 170 from the core piece body 152, and the core piece bodies 152 can be suitably fixed to each other by the adhesive. Accordingly, even in a case where the configuration in which the connector 170 is detached is adopted, the core piece bodies 152 can be firmly fixed to each other by the adhesive injected into the hole 153 while the core piece bodies 152 are connected to each other by the connector 170 and the core piece bodies 152 are held in an annular assembled state.

According to this example embodiment, the stator core 150 is a core body having an annular shape surrounding the central axis J extending in the axial direction. The core body includes the plurality of core pieces 151 connected to each other along the circumferential direction. The core piece 151 includes the core piece body 152 and the connector 70 fixed to the core piece body 152. The connectors 70 in the core pieces 151 adjacent to each other in the circumferential direction include the rotating connection portions 73 which are connected to each other to be rotatable about the rotation axis C extending in the axial direction, and the rotation stopping portions 74 and 75 which come into contact with each other in the radial direction. In such a configuration, as described in the first example embodiment, the assembly efficiency of the annular stator core 150 can be improved.

Although the example embodiments of the present disclosure have been described above, the configuration described in the example embodiments and the combinations of the elements are merely examples, and therefore addition, omission, substation and other alterations may be appropriately made within the scope of the present disclosure. Also note that the present disclosure is not limited by the example embodiments.

For example, an aspect in which the connector 70 is attached to both axial sides of the core piece body 52 of the rotor core 50 has been described as the first example embodiment, and an aspect in which the connector 170 is attached to one axial side of the core piece body 152 of the stator core 150 has been described as the second example embodiment, but the present disclosure is not limited thereto. For example, the connector 170 may be attached to both axial sides of the core piece body 152 of the stator core 150, or the connector 70 may be attached only to one axial side of the core piece body 52 of the rotor core 50.

As the modification of the first example embodiment, the rotor core 50 mounted with the connector 70 detached has been described. However, a similar modification may be applied to the stator core 150. When the connector 170 is configured to be detached in the stator core 150, the connector 170 does not need to have the same shape overlapping the core piece body 152 as illustrated in FIG. 7, and may have a shape overlapping only the core back portion 150a.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A core body with an annular shape surrounding a central axis extending in an axial direction, the core body comprising:
core pieces connected to each other along a circumferential direction; wherein
each of the core pieces includes:
a core piece body; and
a connector fixed to the core piece body; and
the connectors in the core pieces adjacent to each other in the circumferential direction include:
rotating connection portions which are connected to each other to be rotatable about a rotation axis extending in the axial direction; and
rotation stopping portions which come into contact with each other in a radial direction.

2. The core body according to claim 1, wherein
each of the connectors includes a first plate-shaped portion and a second plate-shaped portion overlapping with each other in the axial direction;
the first plate-shaped portion includes a first protruding portion protruding to one side in the circumferential direction with respect to the second plate-shaped portion;
the second plate-shaped portion includes a second protruding portion protruding to another side in the circumferential direction with respect to the first plate-shaped portion;
in the core pieces adjacent to each other in the circumferential direction, the first protruding portion in one of the core pieces and the second protruding portion in another of the core pieces overlap each other when viewed in the axial direction; and
the rotating connection portion is provided in each of the first protruding portion and the second protruding portion.

3. The core body according to claim 2, wherein
each of the first plate-shaped portion and the second plate-shaped portion includes the rotation stopping portions at two end portions in the circumferential direction;
the rotation stopping portion provided at an end portion of the first plate-shaped portion on one side in the circumferential direction is provided adjacent to a radially inner side of the core body;
the rotation stopping portion provided at an end portion of the first plate-shaped portion on another side in the circumferential direction is provided adjacent to a radially outer side of the core body;
the rotation stopping portion provided at an end portion of the second plate-shaped portion on one side in the circumferential direction is provided adjacent to the radially outer side of the core body; and
the rotation stopping portion provided at an end portion of the second plate-shaped portion on another side in the circumferential direction is provided adjacent to the radially inner side of the core body.

4. The core body according to claim 2, wherein
an outer shape of the first plate-shaped portion and an outer shape of the second plate-shaped portion are reverse to each other in the circumferential direction when viewed in the axial direction.

5. The core body according to claim 2, wherein
the rotating connection portion includes a through-hole centered on the rotation axis.

6. The core body according to claim 2, wherein
the core piece body includes a hole centered on the rotation axis at a position where the first protruding portion and the second protruding portion overlapping each other overlap when viewed in the axial direction.

7. The core body according to claim 2, wherein
the core piece body includes third plate-shaped portions laminated in the axial direction; and
a material of the first plate-shaped portions and a material of the second plate-shaped portions are a same material as that of the third plate-shaped portions.

8. The core body according to claim 1, wherein
the rotation stopping portion includes a fitting portion which fits with another rotation stopping portion which is in contact with the rotation stopping portion in the radial direction.

9. The core body according to claim 1, wherein
the connectors are provided on two axial sides of the core piece bodies.

10. The core body according to claim 1, wherein
the core piece bodies adjacent to each other in the circumferential direction are connected when a convex surface portion provided at a circumferential end portion of a first one of the core piece bodies is fitted into a concave surface portion provided at a circumferential end portion of a second core piece body; and
the concave surface portion and the convex surface portion have an arc shape centered on the rotation axis when viewed in the axial direction.

11. A core body with an annular shape surrounding a central axis extending in an axial direction, the core body comprising:
core pieces connected to each other along a circumferential direction; wherein
the core pieces each include core piece bodies;
the core piece bodies include a hole recessed in the axial direction;
in the core piece bodies of the core pieces adjacent to each other in the circumferential direction, a concave surface portion provided at a circumferential end portion of one of the core piece bodies is fitted into a convex surface portion provided at a circumferential end portion of another of the core piece bodies; and
the concave surface portion and the convex surface portion each have an arc shape centered on a center of the hole when viewed in the axial direction.

12. The core body according to claim 1, wherein
the core body is a rotor core of a rotor included in a motor.

13. The core body according to claim 1, wherein
the core body is a stator core of a stator included in a motor.

14. A motor comprising the core body according to claim 12.

15. A connector which is provided in a core piece which is connected to another core piece along a circumferential direction in a core body having an annular shape surrounding a central axis extending in an axial direction, the connector comprising:
a rotating connection portion that is structured to be connected to another connector provided in a core piece adjacent in the circumferential direction to be rotatable about a rotation axis extending in the axial direction; and
a rotation stopping portion that is in radial contact with the connector provided on the core piece adjacent in the circumferential direction.

16. The connector according to claim 15, further comprising:
a first plate-shaped portion and a second plate-shaped portion overlapping each other in the axial direction; wherein
the first plate-shaped portion includes a first protruding portion protruding to one side in the circumferential direction with respect to the second plate-shaped portion;
the second plate-shaped portion includes a second protruding portion protruding to another side in the circumferential direction with respect to the first plate-shaped portion; and
the rotating connection portion is provided in each of the first protruding portion and the second protruding portion.

17. A method for manufacturing the core body according to claim 1, the method comprising:
attaching the connectors to the core piece bodies;
connecting the connectors to be mutually rotatable about the rotation axis; and
assembling the core piece bodies connected to each other into an annular shape by relatively rotating the core piece bodies about the rotation axis.

18. A method for manufacturing the core body according to claim 11, the method comprising:
molding the core body using a plurality of the connectors connected in a circumferential direction; wherein
the molding of the core body includes:
attaching the connector to the core piece body;
connecting the connectors to the hole to be rotatable about a rotation axis passing through a center of the hole;
assembling the core piece bodies connected to each other into an annular shape by relatively rotating the core piece bodies about the rotation axis;
fixing the core piece bodies to each other; and
detaching the connector from the core piece body.
